(19) United States
(12) Patent Application Publication
(10) Pub. No.: US 2003/0162563 A1
(43) Pub. Date: Aug. 28, 2003

(54) Multi-function wiring device

(76) Inventor: Terry Chih-Hao Chang, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,297

(22) Filed: Feb. 26, 2002

(51) Int. Cl. H04B 1/38

(52) U.S. Cl. 455/556

(57) ABSTRACT

The present invention is a multi-function wiring device includes a first interface, a plurality of second interfaces, a first switch and a second switch. The first interface is used for the insertion of a handheld device. The second interfaces are to connect a computer or any peripheral via a corresponding transmission wire. The first switch couples to the first interface and the second interfaces for users to manually select anyone of the second interfaces. The second switch couples to the first interface, the second interfaces and the first switch. When the second switch is pressed, an electrical connection is set up between the first interface and the second interfaces selected via the first switch. Moreover, the present invention has a charging circuitry for charging the handheld device.

### FIELD OF THE INVENTION

The present invention relates to a multi-function wiring device, and, more particularly, to a multi-function wiring device applicable to a handheld device, integrated with the function of charging, and with a plurality of built-in expandable interfaces.

### BACKGROUND OF THE INVENTION

As shown in FIG. 1, a prior art handheld device 1a, such as a PDA (Personal Digital assistance) or Pocket PC, has a slot 11a disposed on the bottom thereof, which is installed into a communication port 21a of a base 2a. The base 2a has a transmission wire 22a for connecting to a computer or any other peripheral (not shown). The connection of the computer and the handheld device is set up by pressing the “Hotsync” button 23a on the base 2a.

RS-232-compatible transmission wire is a prior embodiment for the transmission wire 22a. However, because the transmission rate of this kind of transmission wire is too low, USB-compatible transmission wire is currently used as the replacement of the RS-232 counterpart. Since the base 2a has only one single transmission wire 22a, meaning the computer or peripheral connected with the base 2a needs to have the corresponding connection slot compatible with the transmission line 22a. Thus, the expandability of the base 2a is limited, and, furthermore, the base 2a is without the function of charging, resulting in the requirement of additional battery charger.

### SUMMARY OF THE INVENTION

The primary objective of the present invention is to provide a multi-function wiring device to replace the prior use base for handheld devices. Not only able to set up the communication between handheld devices and computers or peripherals, the present invention further charges handheld devices by its own built-in charging unit. The most important of all is the present invention is with a variety of transmission interfaces as options for users to select from them for the expandability purpose.

In accordance with the claimed invention, the present invention multi-function wiring device includes a first interface, a plurality of second interfaces, a first switch and a second switch. The first interface is used for the insertion of handheld devices, and the second interfaces are used to connect to a computer or other peripherals via a corresponding transmission wire. The first switch couples to the first interface and the second interfaces, so that users may manually select any second interface, which is compatible with external computers or other peripherals. The second switch couples to the first interface, the second interface and the first switch. When the second switch is pressed, the first interface and the second interfaces chosen by the first switch connect with each other electrically, so that the handheld devices connect to the computer or peripherals.

It is an advantage of the present invention that it provides a variety of interfaces applicable to many kinds of external computers or peripherals. And, furthermore, the present invention is able to charge to handheld devices by its own built-in charging circuitry.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic view of a prior handheld device with a base;

FIG. 2 is a 3D view of the present invention;

FIG. 3 is a circuit block diagram of the present invention; and

FIG. 4 is a schematic view of an embodiment of the present invention.

### DETAILED DESCRIPTION OF THE INVENTION

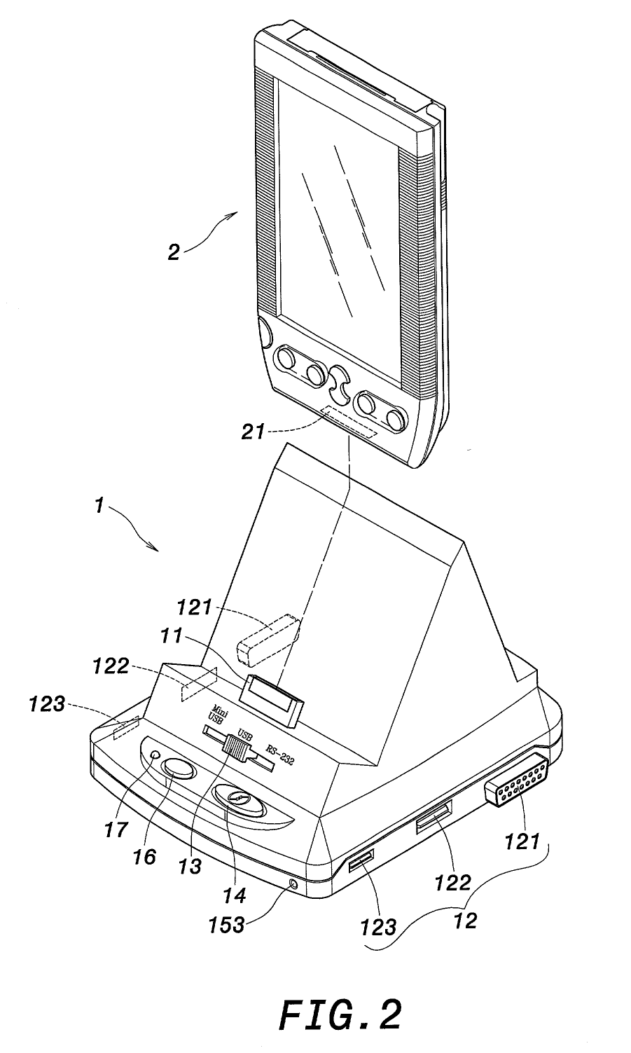

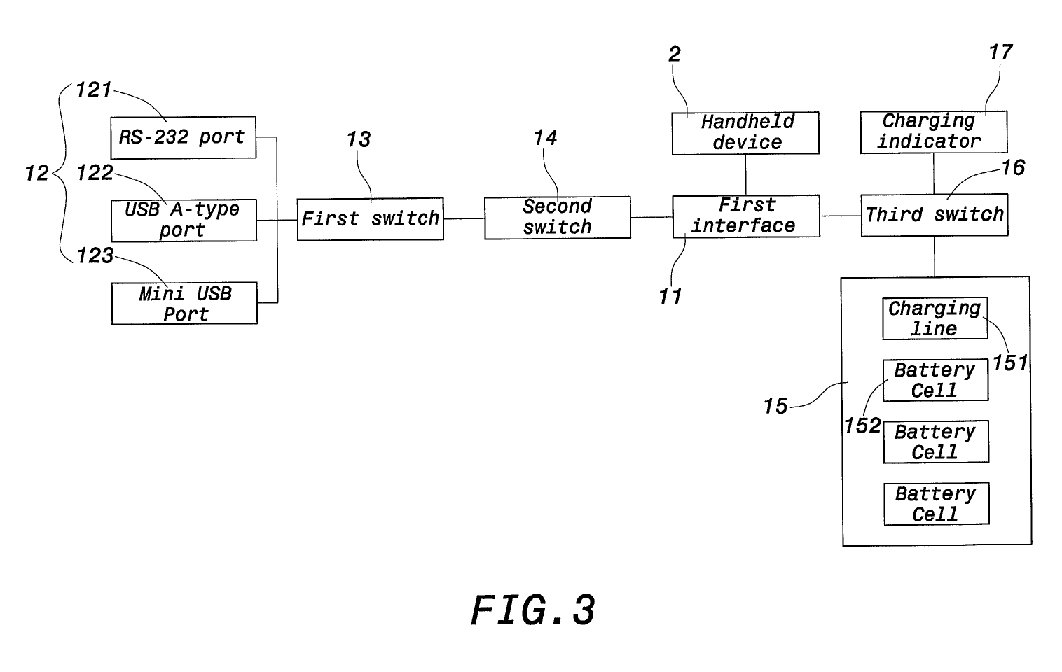

As shown in FIGS. 2 and 3, the present invention multi-function wiring device 1 in conjunction with a handheld device 2. The multi-function wiring device 1 can be used as a charger and is with a plurality of interfaces for such handheld device. The present invention includes a first interface 11, a plurality of second interfaces 12, a first switch 13, a second switch 14, a charging circuitry 15 and a third switch 16.

The first interface 11 is used for the insertion of the slot 21 of the handheld electronic device 2 to connect the multi-function wiring device 1 to the handheld device 2.

The second interfaces 12 is a pair of RS-232 ports 121, USB A-type ports 122 and Mini USB ports 123, respectively, which are to connect to a computer or any other peripheral via a corresponding transmission wire (not shown).

The first switch 13 couples to the second interfaces 12, so that users may manually select any second interface according to the type of communication port of the external peripheral.

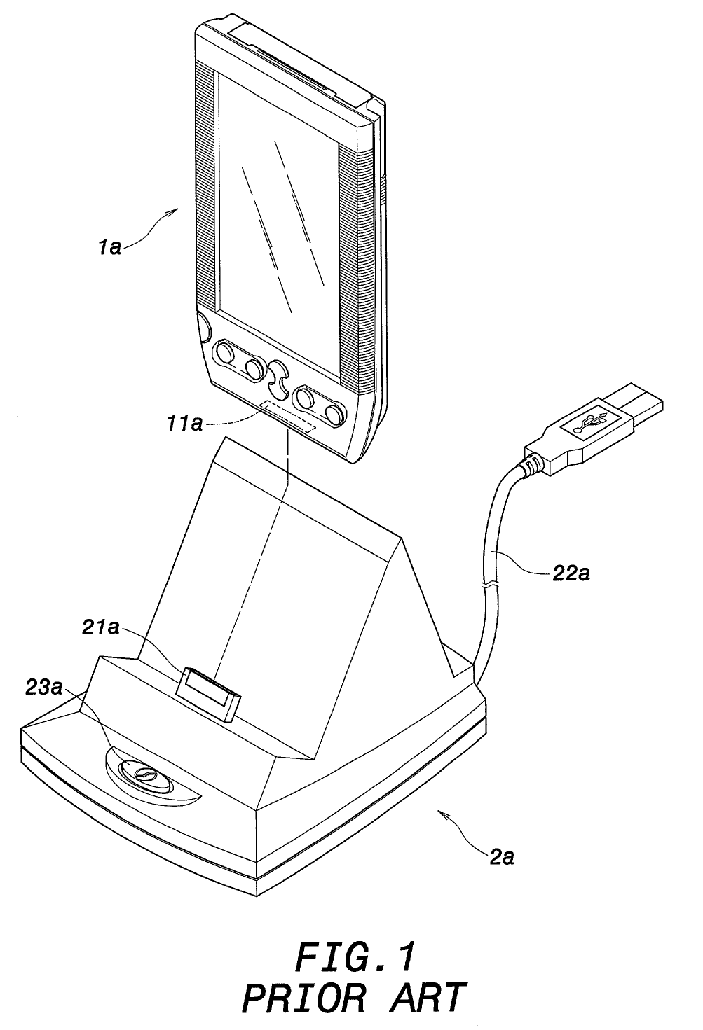

The second switch 14 (similar to Hotsync button 21a of the base 2a shown in FIG. 1) couples to the first interface 11 and the first switch 13. When the second switch 14 is pressed, the first interface 11 and the selected second interface(s) 12 are electrically connected with each other.

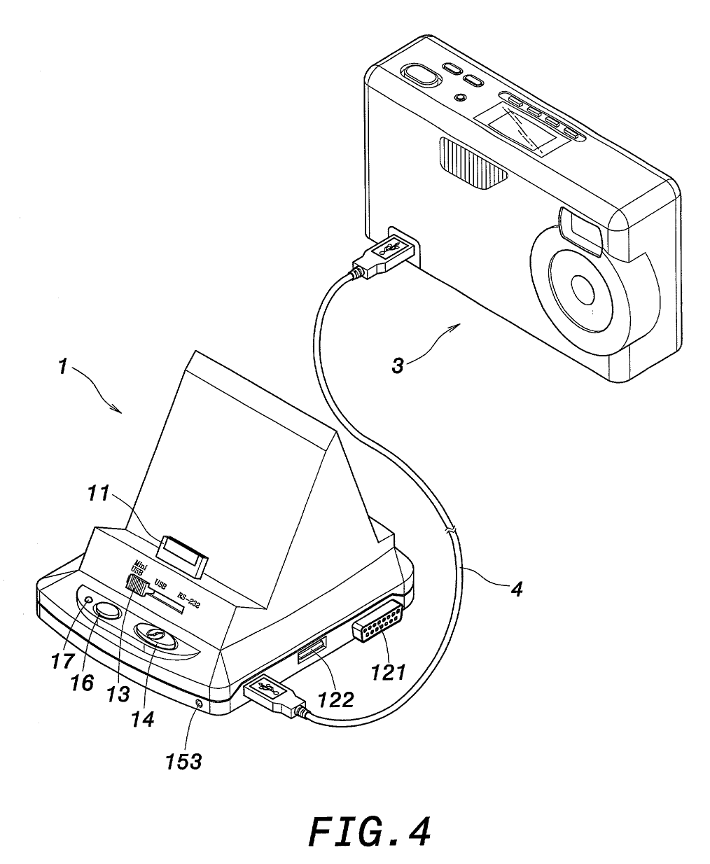

The charging circuitry 15 includes a charging line 151 coupled to a plurality of battery cells 152. The battery cells 152 can be ordinary battery cells, such as No. 4 alkaline battery cells, or rechargeable battery cells. The charging circuitry 15 has an input socket 153 (shown in FIG. 4) for connecting to an external adaptor for the purpose of charging the rechargeable battery cells.

The third switch 16 couples to the first interface 11, the charging circuitry 15 and a charging indicator 17. When the handheld device 2 is inserted into the first interface 11 of the multi-function wiring device 1 for the purpose of power charging, users need to press the third switch 16 to set up the electrical connection between the first interface 11 and the charging circuitry 15. The battery cells 152 of the charging circuitry 15 then provide power to the handheld device 2. The charging indicator 17 is with the red light during the charging process, and turns to green when the handheld device 2 is fully charged.

FIG. 4 is an embodiment of the present invention. When a user try to display images captured by the digital camera 3, which is with a built-in Mini USB port, on the monitor of the handheld device (not shown), only the Mini USB transmission line 4 is used to electrically connect the Mini USB port of the digital camera 3 and the Mini USB port 123 of the multi-function wiring device 1. Meanwhile, the user has to switch the first switch 13 to the “Mini USB” position and then press the second switch 14 to transmit the image data.

Moreover, a peripheral, such as keyboard and scanner, can be connected to the handheld device 2 directly via their own built-in communication ports, without the use of any transmission wire. However, such connection is not applicable to every type of handheld device. The present invention has interfaces corresponding to the second interfaces 12, so that the aforementioned connection is applicable to every type of handheld device via the modification of the internal firmware.

The present invention is a small and portable multi-function wiring device that integrates a variety of interfaces for the flexibility and expandability purpose of the handheld device.

Although the substantial functions and uniqueness of the present invention has been illustrated and described with reference to the preferred embodiment thereof, it should be understood that it is in no way limited to the details of such embodiment but is capable of numerous modifications within the scope of the appended claims.

What is claimed is:

1. A multi-function wiring device, comprising:
a first interface for the insertion of a handheld device;
at least one second interface for connecting a computer or other peripherals via a corresponding transmission wire;
a first switch coupling to said first interface and said second interface for users to manually select said second interface for external connection; and
a second switch coupling to said first interface, said second interface, and said first switch;
wherein said handheld device processes data communication with said computer or peripherals while said second switch is pressed.

2. The multi-function wiring device as cited in claim 1, wherein said handheld device is a PDA (Personal Digital Assistance) or a Pocket PC.

3. The multi-function wiring device as cited in claim 1, wherein said second interface is a RS 232 port, a USB A-type port, and/or a Mini USB port.

4. The multi-function wiring device as cited in claim 1 further comprising:
a charging unit having a charging circuitry line coupling to a plurality of battery cells; and
a third switch coupling to said first interface and said charging circuitry;
wherein said first interface electrically connects with said charging circuitry to provide power to said handheld device when said third switch is pressed.

5. The multi-function wiring device as cited in claim 4, wherein said charging circuitry further couples to a charging indicator.

6. The multi-function wiring device as cited in claim 4, wherein said battery cells are ordinary battery cells or rechargeable battery cells.

7. The multi-function wiring device as cited in claim 4, wherein said charging circuitry connects to an external adaptor for the purpose of charging said rechargeable battery cells.
